(19) United States
(12) Patent Application Publication
(10) Pub. No.: US 2011/0104545 A1
(43) Pub. Date: May 5, 2011

(54) Battery, Particularly for a Hybrid Drive

(75) Inventors: Jens Meintschel, Bernsdorf (DE); Dirk Schroeter, Winnenden (DE)

(73) Assignee: Daimler AG, Stuttgart (DE)

(21) Appl. No.: 12/672,166

(22) PCT Filed: Jul. 29, 2008
(86) PCT No.: PCT/EP08/06228

§ 371 Date: Jan. 19, 2011

(30) Foreign Application Priority Data
Aug. 6, 2007 (DE) 10 2007 036 863.3
Dec. 20, 2007 (DE) 10 2007 063 190.3

(51) Int. Cl. H01M 10/50

(52) U.S. Cl. 429/120

(57) ABSTRACT

The invention relates to a battery comprising at least one temperature control unit that is configured as a cooling plate, and at least two galvanic individual cells, with a metal housing each, wherein the metal housing has an extension, which can be accommodated at least partially in a respective receptacle of the temperature control unit.

### BACKGROUND AND SUMMARY OF THE INVENTION

This application is a national stage of PCT International Application No. PCT/EP2008/006228, filed Jul. 29, 2008, which claims priority under 35 U.S.C. §119 to German Patent Application No. 10 2007 036 863.3, filed Aug. 6, 2007 and No. 10 2007 063 190.3, filed Dec. 20, 2007, the entire disclosures of which are herein expressly incorporated by reference.

The invention relates to a battery including several individual cells, which have, in at least an edge region, at least indirect heat conducting contact with a temperature-effective temperature control unit, such as is used, for example, in the energy technology (and especially in battery-operated vehicle technology).

Batteries (especially so-called high performance batteries based on nickel metal hydride or lithium) are often used to drive vehicles, for example electric or hybrid vehicles. Such batteries, typically comprise stacked prismatic galvanic cells (also called individual cells), several of which are combined to form the battery. The galvanic individual cells, however, can heat up a great deal during operation, and thus have to be cooled.

For temperature control, preferably for cooling of several individual cells arranged within a battery box, it is known to position at least one edge of the individual cells at least indirectly on an effective temperature control device.

Especially high-performance batteries (e.g., lithium ion cells) for mild hybrid vehicles have to be cooled intensively to discharge the resulting lost heat. The temperature control unit is preferably formed as a cooling plate for this, and especially as a heat exchanger. In an advantageous manner, the cooling is an indirect cooling supported on a fluid through the air conditioning cycle or for example a direct cooling by means of the fluid, which can flow through the temperature control unit and the air conditioning unit simultaneously.

Heretofore, during the cooling by the air conditioning cycle, a cooling plate or temperature control-effective temperature control unit is arranged at the cell block, which is cooled by evaporating air conditioning. The heat is guided into the cooling plate by means of separate heat conducting plates, which are arranged between the individual cells. This solution is cost- and installation space-intensive.

From German patent document DE 10 2005 031 504 A1 is known a prismatic battery, which consists of several individual cells, of which at least two are combined to form a prismatic module. Respectively at least two of the modules are again stacked to form the battery and clamped to each other between two end plates. The prismatic battery further comprises at least one cooling body, which is in heat conducting contact with at least one of the modules This cooling body has at least one cooling fin according to the invention, which is formed parallel to the force direction of the clamping.

It is an object of the invention to provide a battery with an improved cooling, where the costs and the installation space requirement are reduced.

This and other objects and advantages are achieved by the battery according to the invention, which comprises at least one cooling plate and at least two galvanic individual cells with a housing each, especially a metal housing. Each of the housings has an extension, which can be received at least partially in a receptacle formed as a recess of a temperature control-effective temperature control unit (also called cooling plate). In this manner, the lost heat is discharged directly via the metal housing, which is for example formed of aluminum, to the cooling plate. Compared to the conventional form of the metal housing, the battery according to the invention is provided with an extension in regions of an edge, which extension can be received at least partially in the receptacle of the temperature control unit. Costs and installation space can be reduced with the battery according to the invention.

The housing (also called a cell housing) is thereby counter-sunk in the receptacle of the cooling plate or temperature control unit in a sensible manner, to increase the heat transfer cross section. If need be, especially the cell wall of the housing can be thickened on its full surface or partially.

In a special further development of the invention, the temperature control unit has a receptacle in the form of a recess for each of the individual cells. The individual cells are thereby fixed well and safe from vibrations.

In a special further development of the invention, an individual cell is prismatic and especially cuboidal. This enables an easy stacking, a good installation space usage, and a stable position by a possible planar arrangement or pressing of the individual parts to each other.

In a special further development of the invention, one individual cell is formed in a cuboidal manner, wherein the length of the long side of an edge which can be arranged in the receptacle is at least the five, preferably at least ten, and especially preferred at least twenty times of the length of the corresponding narrow side of this edge side. For this, the individual cells are especially formed as flat cells. This enables a good fixation on the bottom side and also fixation on the edge side. The individual cells can thereby be fixed and held in a vibration-safe manner. Especially with individual cells formed as flat cells, an easy stacking, a good installation space usage, a stable position by a possible planar arrangement or pressing to each other, and a largely uniform temperature control between both flat sides result due to low thickness.

In a special further development of the invention, the housing walls of the individual cells have a material which conducts heat well at least in the region of the receptacle. This enables a good heat contacting in a simple manner.

In a special further development of the invention, the housing walls of adjacent individual cells which conduct heat well are spaced from each other at least in regions and form a preferably fluid-permeable flow-through channel in this manner, which enables a temperature control through a large area for the individual cells.

In a special further development of the invention, the distance of two receptacles is larger than the corresponding largest thickness of an individual cell. It is further smaller than threefold (preferably double) this measure. A fluid-permeable flow-through channel is thereby formed in a simple manner.

In a special further development of the invention, the distance of two receptacles approximately corresponds to the sum of the corresponding largest thickness of an individual cell and the corresponding clear widths of the associated flow-through channel. Such a variable dimensioning of the flow-through channel leads to saving of installation space.

In a special further development of the invention, the housing of an individual cell has two housing plates, which are connected to each other at least on their edge. At least one (preferably the front) housing plate on the inflow side of an individual cell is extended and arranged at least in regions within the receptacle of the temperature control unit. A simple housing is enabled hereby, which can be produced in an economic manner. The invention is especially suitable for flat cells, which can be fixed well at the bottom and also at the edge, whereby a high safety against vibration results, easy stacking, a good installation space usage, a stable position by a possible planar arrangement or pressing to each other, a largely uniform temperature control between both flat sides due to low thickness.

In a special further development of the invention, the housing of an individual cell has two housing plates, which are connected to each other at least indirectly on their edge. At least one housing plate of two adjacent individual cells is provided with spacers to form a flow-through channel. This results in a simple housing, which can be produced in a simple and economic manner. When forming the individual cell as a flat cell, a good fixation at the bottom side and also fixation at the edge is possible, whereby the individual cells have the following advantages: a safety against vibration, an easy stacking, a good installation space usage, a stable position by a possible planar arrangement or pressing to each other, a largely uniform temperature control between both flat sides due to low thickness, securing of the clear width of the flow-through channels especially with bipolar cells, good heat conduction with electrical insulation.

In a special further development of the invention, a spacer is integrated in a housing plate. In a special further development of the invention, a spacer projects from the housing plate of an individual cell in the direction of the housing plate of an adjacent individual cell. In a special further development of the invention, a spacer is formed as a material bulge and/or a protuberance and/or a ridge, which is driven out or punched out of the corresponding housing wall. This is especially simple and economic during production.

In a special further development of the invention, the battery has a fluid-permeable battery box in which the individual cells are arranged. A good temperature control, a closed system, a uniform temperature in all individual cells, at best a low temperature gradient in the flow direction results thereby.

In a special further development of the invention, the fluid is connected at least indirectly in a heat conducting manner to the heat conducting medium of an air conditioning unit, preferably of a motor vehicle, whereby a simple and effective temperature control is enabled.

In a special further development of the invention, a heat exchanger is arranged for the heat transfer between the fluid and the heat conducting medium. This represents a simple and economic construction.

In a special further development of the invention, a gap resulting between the receptacle (groove) in the cooling plate and the cell housing is filled with a casting mass which conducts heat well, whereby an improved thermal contacting is achieved.

In a special further development of the invention, in the region of the groove between the respective groove inner wall and the housing of an individual cell, a preferably U-shaped insert piece (spacer) is arranged, whose half wall thickness approximately corresponds to the difference of the thickness of the housing in this region and the corresponding clear width of the groove in this region. This enables an improved thermal contact.

In a special further development of the invention, especially with bipolar cells, an electrically insulating, but preferably well heat conducting casting mass is arranged in the remaining intermediate space between the groove and the housing. This enables a good heat conduction with electrical insulation especially with bipolar cells.

In a special further development of the invention, especially with bipolar cells, the insert piece can be manufactured of an electrically non-conductive but preferably well heat conducting material. This enables a good heat conduction with an electrical insulation especially with bipolar cells.

Other objects, advantages and novel features of the present invention will become apparent from the following detailed description of the invention when considered in conjunction with the accompanying drawings.

### BRIEF DESCRIPTION OF THE DRAWINGS

FIGS. 1a and 1b are perspective and side views, respectively, of a flat galvanic individual cell with a metal housing, which has an extension for heat discharge;

FIGS. 2a and 2b show the galvanic individual cell of FIG. 1 with U-shaped insert pieces formed as spacers in the region of the extension;

FIG. 3 is a perspective view of an arrangement of several of the galvanic individual cells of FIG. 2, which are contacted amongst each other by separate cell poles welded to each other;

FIG. 4 is a side view of the arrangement of FIG. 3;

FIG. 5 is a perspective view of a battery, comprising the arrangement of FIGS. 3 and 4, wherein the extensions of the galvanic individual cells are arranged in a counter-sunk manner in respective recesses of a cooling plate;

FIG. 6 is a side view of the battery of FIG. 5; and

FIG. 7 is a detailed view of the battery of FIG. 6, wherein the recesses around the extensions are filled with a heat conducting casting mass.

### DETAILED DESCRIPTION OF THE DRAWINGS

Corresponding parts are provided with the same reference numerals in all figures.

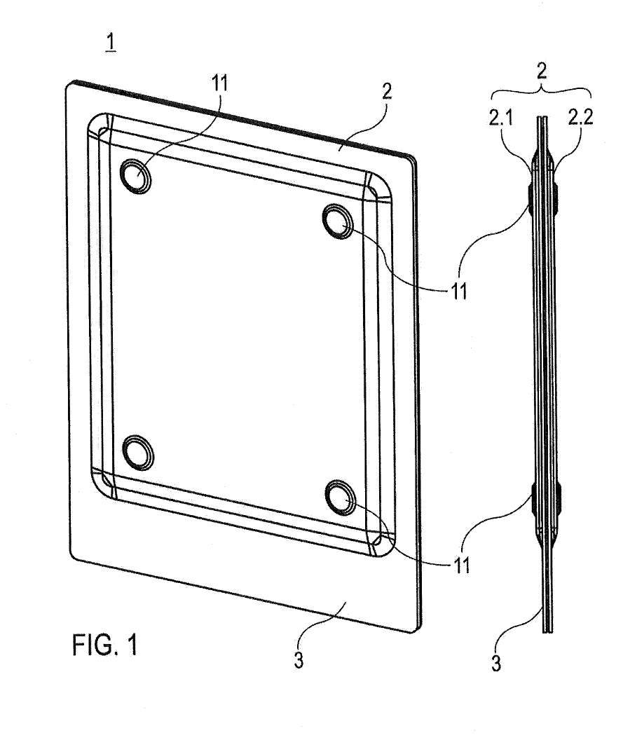

FIGS. 1a and 1b show a perspective view and a side view of a flat galvanic individual cell 1 with a housing 2 formed especially as a metal housing, the cell having an extension for heat discharge. The galvanic individual cell 1 is formed as a bipolar cell with two housing halves 2.1 and 2.2, which are separated by an insulator. Differently formed galvanic individual cells 1 can also be provided. Four spacers 11 formed for example as ridges are introduced into the wall of at least one of the housing halves 2.1, 2.2.

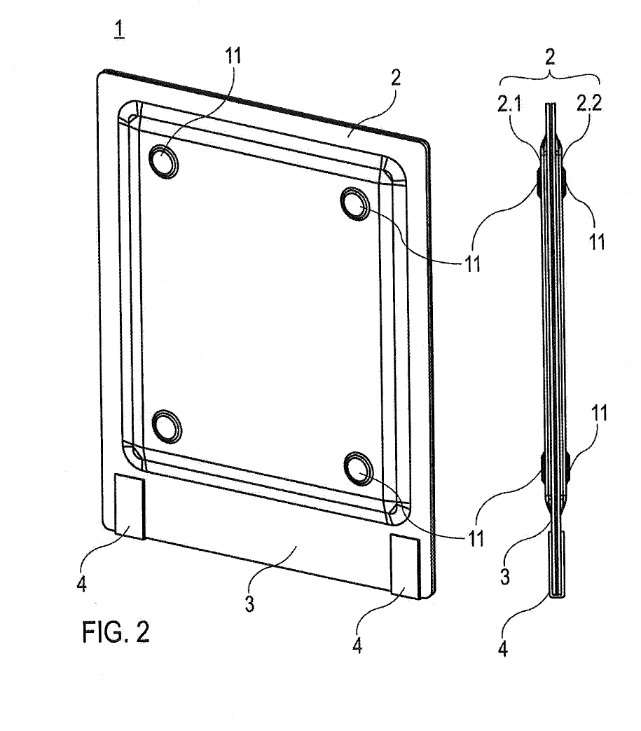

In FIGS. 2a and 2b, the galvanic individual cell of FIG. 1 is shown with U-shaped insert pieces 4 functioning as spacers in the region of the extension 3.

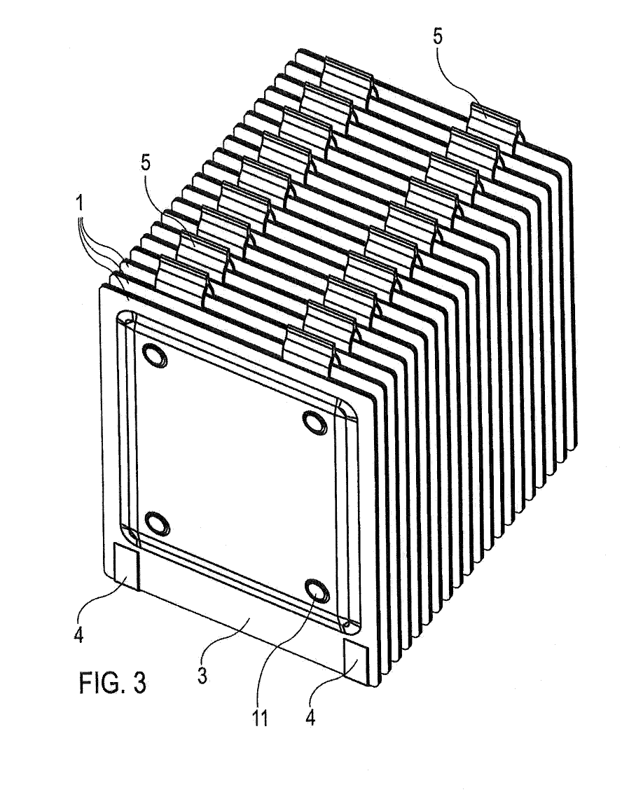

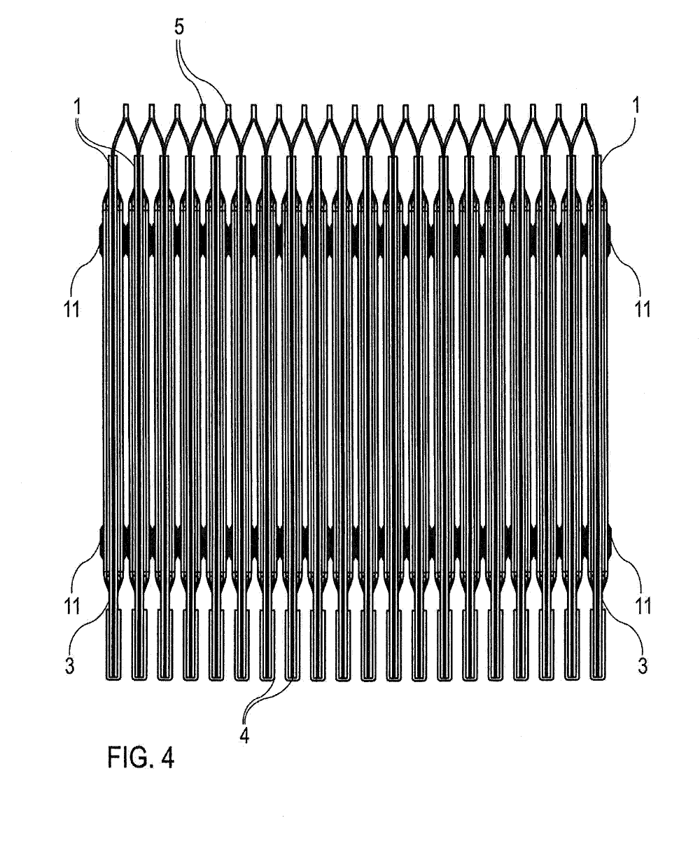

In FIG. 3 shows a perspective view of an arrangement of several of the galvanic individual cells of FIG. 2, which are contacted amongst each other by separate cell poles 5 welded to each other. FIG. 4 shows a side view of the arrangement. The contacting can also take place in another manner.

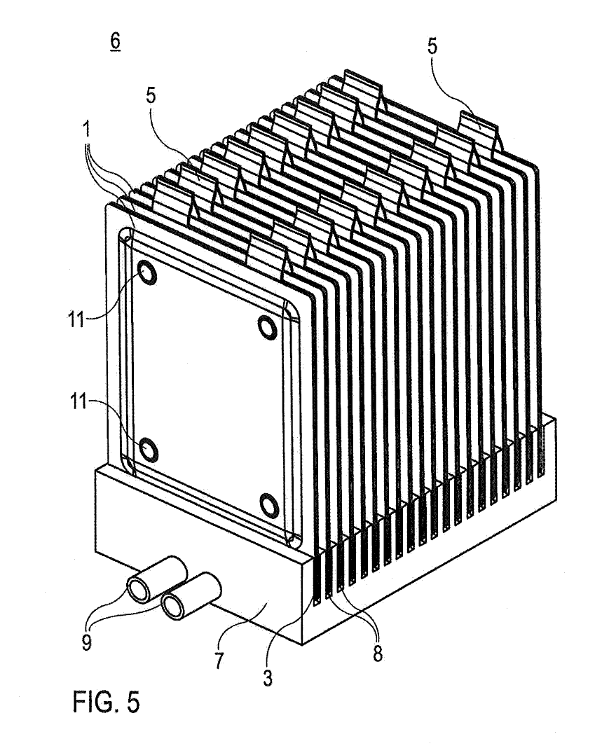

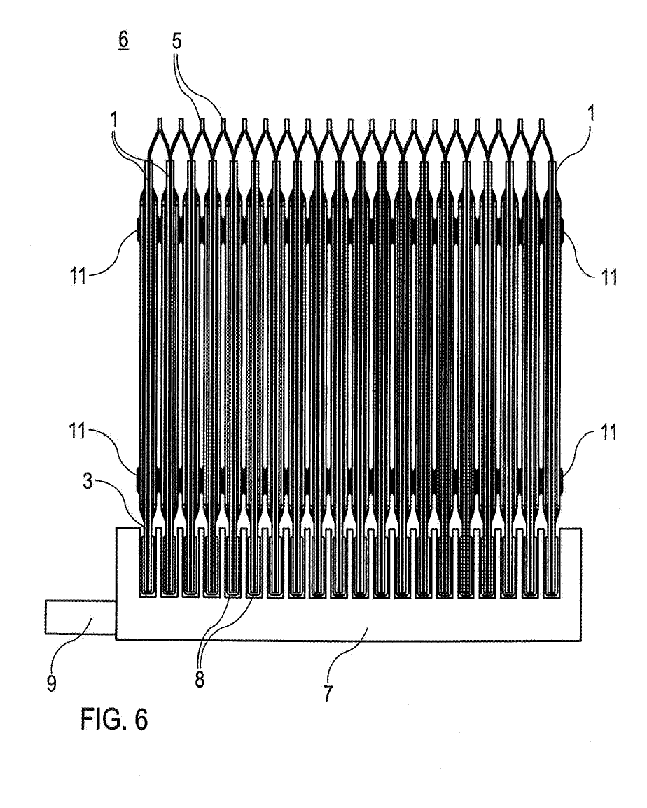

In FIG. 5, a perspective view of a battery 6 is shown, which comprises the arrangement of FIGS. 3 and 4 and a temperature control unit 7 formed for example as a cooling plate. The extensions 3 of the galvanic individual cells 1 are arranged in a counter-sunk manner in respective receptacles 8 in the form of recesses of the temperature control unit 7. The temperature control unit 7 has media connections 9, through which a cooling medium can flow into the temperature control unit 7 through channels, not shown. In FIG. 6, the battery is shown in a side view.

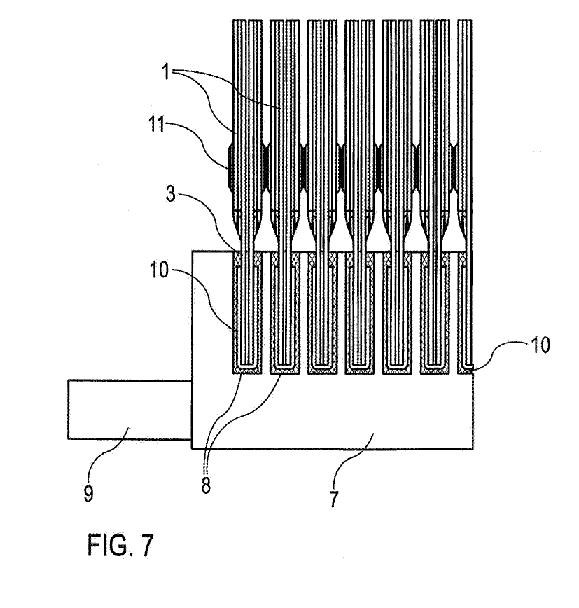

FIG. 7 shows a detailed view of the battery of FIG. 6, wherein the recesses or receptacles 8 around the extensions 3 are filled with a heat conducting casting mass 10.

The extension 3 can be counter-sunk partially or completely into the receptacle 8 of the temperature control unit 7. The extension 3 can be thickened throughout or partially if necessary.

The temperature control unit 7 has a respective receptacle 8 for each of the galvanic individual cells 1, so that these are fixed in a vibration-safe manner.

The galvanic individual cells 1 are preferably formed in a prismatic (especially cuboidal) manner, so that they can be stacked in a simple manner. A good installation space usage and a stable position of the battery 6 results at the same time.

The galvanic individual cell 1 can be formed in a cuboidal manner in such a way that the length of a long edge of the extension is at least five times (or preferably at least ten, and especially preferred at least twenty times) the length of the corresponding narrow edge of the extension 3. A good fixation on the bottom and on the edge is possible with individual cells 1 formed in such a flat manner. The temperature control between the housing halves 2.1, 2.2 is possible in a largely uniform manner due to the small thickness.

The extension 3 can be formed of a material which conducts heat especially well, so that an improved heat conduction results.

The galvanic individual cells 1 can be spaced from each other at least in regions in such a manner that the resulting intermediate spaces can be flown through by a fluid for additional cooling. The distance between respectively two receptacles 8 of the temperature control unit 7 can especially be larger for this than the corresponding largest thickness of a galvanic individual cell 1. The distance is preferably smaller than three times (especially preferred less than double) this measure. The spacers 11 preferably serve for adjusting the distance.

The distance between two adjacent receptacles 8 can preferably approximately correspond to the sum of the largest thickness of one of the galvanic individual cells 1 and the clear width of the associated intermediate space.

The metal housing 2 of a galvanic individual cell 1 can have two housing plates 2.1, 2.2, which are connected to each other on their edges. At least one of the housing plates 2.1, 2.2 of a galvanic individual cell 1 is extended and arranged at least in regions within the receptacle 8. A simple metal housing 2 formed in such a manner is economic in its production.

The housing halves 2.1, 2.2 can be connected at least indirectly at their edges. At least one of the housing halves 2.1, 2.2 of two adjacent galvanic individual cells 1 can be provided with the spacers 11 for forming the intermediate space and the securing of its clear width. The respective spacer 11 can be integrated in one of the housing halves 2.1, 2.2, especially in such a manner that the spacer 11 projects from the housing half 2.1, 2.2 of one of the galvanic individual cells 1 in the direction of one of the housing halves 2.1, 2.2 of one of the adjacent galvanic individual cells 1.

The respective spacers 11 can be formed as a material bulge and or a protuberance and/or a ridge, which is formed the corresponding housing half 2.1, 2.2.

The battery 6 can be arranged in a battery box, wherein the galvanic individual cells 1 are arranged within the battery box which can be flown through by a fluid, so as to achieve a largely uniform temperature control of all galvanic individual cells 1.

The fluid can be connected at least indirectly to a heat conducting medium of an air conditioning unit in a heat conducting manner, preferably of a motor vehicle. A heat exchanger can be arranged for this.

The recess 8 in the temperature control unit 7 can be filled around the extension with a casting mass 10 which conducts heat well.

At least the preferably U-shaped spacer or the insert piece 4 (also called spacer) can be arranged between the receptacle 8 and the extension 3, whose half wall thickness approximately corresponds to the difference of the thickness of the extension 3 in this region and the corresponding clear width of the receptacle 8 in this region.

Especially when the galvanic individual cell 1 is formed as a bipolar cell, the heat conducting casting mass 10 can be formed in an electrically insulating manner.

Especially with bipolar cells, the spacer or the insert piece 4 can also be manufactured of an electrically non-conductive but preferably well heat conducting material.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

1.-22. (canceled)

23. A battery comprising a plurality of individual cells; wherein:
at least in an edge region, the individual cells have at least an indirect heat-conducting contact with a temperature-effective temperature control unit; and
the temperature control unit has a receptacle for receiving, at least partially, a region of the edge of an individual cell.

24. The battery according to claim 23, wherein the temperature control unit has a receptacle for each of the individual cells.

25. The battery according to claim 23, wherein:
the temperature control unit is formed as a cooling plate; and
a casting mass which conducts heat well is arranged in a gap between the receptacle and the housing of the individual cell.

26. The battery according to claim 23, wherein in a region of a groove between the receptacle and the housing of an individual cell, an insert piece is arranged, whose half wall thickness corresponds approximately to the difference between the thickness of the housing in this region and a corresponding clear width of the groove in this region.

27. The battery according to claim 26, wherein the insert piece is U-shaped.

28. The battery according to claim 26, wherein a casting mass which is electrically insulating and which conducts heat well, is arranged between the groove and the housing with bipolar individual cells.

29. The battery according to claim 26, wherein the insert piece is an electrically non-conductive material which conducts heat well with bipolar individual cells.

30. The battery according to claim 23, wherein an individual cell is prismatic.

31. The battery according to claim 23, wherein an individual cell is cuboidal.

32. The battery according to claim 23, wherein:
one individual cell is cuboidal; and
the length of a long side of an edge which can be arranged in the receptacle is at least five times, preferably at least ten, and especially preferred at least twenty times the length of a corresponding narrow side of said edge.

33. The battery according to claim 23, wherein:
a region of the edge of the respective individual cell is formed as an extension of the housing walls of the individual cells.

34. The battery according to claim 23, wherein extensions of housing walls of the individual cells are formed in a manner which conducts heat well at least in a region of the receptacle.

35. The battery according to claim 23, wherein housing walls of adjacent individual cells, which housing walls conduct heat well, are spaced from each other, at least in regions, and form a fluid- permeable flow-through channel.

36. The battery according to claim 23, wherein the distance of two receptacles is larger than a corresponding largest thickness of an individual cell.

37. The battery according to claim 23, wherein the distance of two receptacles corresponds approximately to the sum of a corresponding largest thickness of an individual cell and a corresponding clear width of the associated flow-through channel.

38. The battery according to claim 23, wherein:
a housing of an individual cell has two housing plates, which are connected to each other at edges thereof:
at least one housing plate on an inflow side of an individual cell has an extension; and
at least a portion of the extension is arranged within the receptacle.

39. The battery according to claim 23, wherein:
a housing of an individual cell has two housing plates which are connected at least indirectly at their edges;
at least one housing plate of two adjacent individual cells is provided with spacers for forming a flow-through channel.

40. The battery according to claim 24, wherein a spacer is integrated in a housing plate.

41. The battery according to claim 40, wherein said spacer is one of a material bulge, a protuberance and a ridge, which is driven or punched out of the respective housing plate.

42. The battery according to claim 23, wherein:
the battery has a fluid permeable battery box; and
the individual cells are arranged within the fluid-permeable battery box.

43. The battery according to claim 23, wherein a heat transfer fluid is coupled at least indirectly with a heat conducting medium of an air conditioning unit in a heat conducting manner.

44. The battery according to claim 23, wherein a heat exchanger is arranged for the heat transfer between the fluid and the heat conducting medium.

45. The battery according to claim 23, wherein the metal housing is thickened at least in sections.
